(19) United States
(12) Patent Application Publication
(10) Pub. No.: US 2015/0248907 A1
(43) Pub. Date: Sep. 3, 2015

(54) RECESSED IRMN READER SENSOR DESIGN WITH HIGH HK APPLIED TO BOTH REFERENCE AND PIN LAYERS

(71) Applicant: HGST Netherlands B.V., Amsterdam (NL)

(72) Inventors: James Mac FREITAG, Sunnyvale, CA (US); Zheng GAO, San Jose, CA (US); Simon Huangchung LIAO, Fremont, CA (US); Suping SONG, Fremont, CA (US)

(73) Assignee: HGST NETHERLANDS B.V., Amsterdam (NL)

(21) Appl. No.: 14/194,613

(22) Filed: Feb. 28, 2014

(51) Int. Cl. G11B 5/60; G11B 5/11

(52) U.S. Cl. CPC G11B 5/6082; G11B 5/11

(57) ABSTRACT

The embodiments disclosed generally relate to a magnetic read head having a recessed antiferromagnetic layer and a recessed pinned magnetic layer. The recessed pinned magnetic layer is only partially recessed from the MFS, but the recess amount is the same amount as the antiferromagnetic layer. The recess is between about 50 nm and about 200 nm. Processing the pinned magnetic layer and the antiferromagnetic layer and its seed layers at an oblique angle results in an increase in the anisotropy field.

### BACKGROUND OF THE INVENTION

. 1Field of the Invention

Embodiments disclosed herein generally relate to a magnetic read head for use in a hard disk drive (HDD).

2. Description of the Related Art

The heart of a computer is a magnetic disk drive which typically includes a rotating magnetic disk, a slider that has read and write heads, a suspension arm above the rotating disk and an actuator arm that swings the suspension arm to place the read and/or write heads over selected circular tracks on the rotating disk. The suspension arm biases the slider towards the surface of the disk when the disk is not rotating but, when the disk rotates, air is swirled by the rotating disk adjacent a media facing surface (MFS), such as an air bearing surface (ABS), of the slider causing the slider to ride on an air bearing a slight distance from the surface of the rotating disk. When the slider rides on the air bearing, the write and read heads are employed for writing magnetic impressions to and reading magnetic signal fields from the rotating disk. The read and write heads are connected to processing circuitry that operates according to a computer program to implement the writing and reading functions.

The read head typically utilizes a spin valve sensor, also referred to as a magnetoresistive sensor. The sensor at the MFS typically includes a barrier layer sandwiched between a pinned layer and a free layer, and an antiferromagnetic layer for pinning the magnetization of the pinned layer. The magnetization of the pinned layer is pinned perpendicular to the MFS and the magnetic moment of the free layer is located parallel to the MFS, but free to rotate in response to external magnetic fields.

The need for ever increased data density is pushing researchers to develop data recording systems that can read and record ever smaller bit lengths in order to increase the density of data recorded on a magnetic medium. This has led to a push to decrease the gap thickness of a read head. However, the amount by which such gap thickness can be decreased has been limited by physical limitations of sensors and also by the limitations of currently available manufacturing methods.

A self-pinned sensor in which the antiferromagnetic layer is reduced in thickness or removed completely so as to not provide a pinning field for the pinned layer structure provides a method to reduce the read gap. The self-pinned sensor is, however, sensitive to magnetic disturbances caused, for instance, by a head-media impact, which may flip the polarity of the amplitude of the output signal from the read head. Such a failure would reduce the reliability of the recording system.

Therefore, there is a need for an improved magnetic head that can reduce the read gap thickness while still preserving the reliability of the magnetic head.

### SUMMARY OF THE INVENTION

The embodiments disclosed generally relate to a magnetic read head having a recessed antiferromagnetic layer and a recessed pinned magnetic layer. The recessed pinned magnetic layer is only partially recessed from the MFS, but the recess amount is the same amount as the antiferromagnetic layer. The recess is between about 50 nm and about 200 nm. Processing the pinned magnetic layer and the antiferromagnetic layer and the antiferromagnetic seed layers at an oblique angle results in an increase in the anisotropy field.

In one embodiment, a magnetic read head comprises a bottom shield having an end that forms a portion of an MFS; a top shield disposed over the bottom shield, wherein the top shield has an end that forms a portion of the MFS; seed layers and an antiferromagnetic layer disposed over the bottom shield and recessed from the MFS; a pinned magnetic layer disposed on the antiferromagnetic layer, wherein a first portion of the pinned magnetic layer is recessed from the MFS and wherein the pinned magnetic layer has been processed at an oblique angle; a non-magnetic coupling layer disposed over the pinned magnetic layer, wherein the coupling layer forms a portion of the MFS; a reference magnetic layer disposed over the coupling layer, wherein the reference magnetic layer forms a portion of the MFS; an insulating layer disposed over the reference magnetic layer, wherein the insulating layer forms a portion of the MFS; a free magnetic layer disposed over the insulating layer, wherein the free magnetic layer forms a portion of the MFS; and a capping layer disposed over the free magnetic layer, wherein the capping layer forms a portion of the MFS. The seed layers and the antiferromagnetic layer may be deposited at an oblique angle (i.e., an angle greater than 0, but less than 90 degrees). The oblique angle of deposition results in an increase in the anisotropy field.

In another embodiment, a magnetic read head comprises a bottom shield having an end that forms a portion of an MFS; a top shield disposed over the bottom shield, wherein the top shield has an end that forms a portion of the MFS; seed layers and an antiferromagnetic layer disposed over the bottom shield, wherein the antiferromagnetic layer is recessed from the MFS and wherein the antiferromagnetic layer has been processed at an oblique angle; a pinned magnetic layer disposed on the antiferromagnetic layer, wherein a portion of the pinned magnetic layer is recessed from the MFS and wherein the pinned magnetic layer has been processed at an oblique angle; a coupling layer disposed over the pinned magnetic layer, wherein the coupling layer forms a portion of the MFS; a reference magnetic layer disposed over the coupling layer, wherein the reference magnetic layer forms a portion of the MFS; an insulating layer disposed over the reference magnetic layer, wherein the insulating layer forms a portion of the MFS; a free magnetic layer disposed over the insulating layer, wherein the free magnetic layer forms a portion of the MFS; and a capping layer disposed over the free magnetic layer, wherein the capping layer forms a portion of the MFS. The seed layers and the antiferromagnetic layer may be deposited at an oblique angle (i.e., an angle greater than 0, but less than 90 degrees). The oblique angle of deposition results in an increase in the anisotropy field.

In another embodiment, a magnetic read head comprises a bottom shield having an end that forms a portion of an MFS; a top shield disposed over the bottom shield, wherein the top shield has an end that forms a portion of the MFS; seed layers and an antiferromagnetic layer disposed over the bottom shield, wherein the antiferromagnetic layer is recessed from the MFS, wherein the antiferromagnetic layer has been processed at an oblique angle and wherein the antiferromagnetic layer is recessed from the MFS by a distance of between about 50 nm and about 200 nm; a pinned magnetic layer disposed on the antiferromagnetic layer, wherein a portion of the pinned magnetic layer is recessed from the MFS, wherein the pinned magnetic layer has been processed at an oblique angle and wherein the first portion of the pinned magnetic layer is recessed from the MFS by a distance of between about 50 nm and about 200 nm; a coupling layer disposed over the pinned magnetic layer, wherein the coupling layer forms a portion of the MFS; a reference magnetic layer disposed over the coupling layer, wherein the reference magnetic layer forms a portion of the MFS; an insulating layer disposed over the reference magnetic layer, wherein the insulating layer forms a portion of the MFS; a free magnetic layer disposed over the insulating layer, wherein the free magnetic layer forms a portion of the MFS; and a capping layer disposed over the free magnetic layer, wherein the capping layer forms a portion of the MFS. The seed layers and the antiferromagnetic layer may be deposited at an oblique angle (i.e., an angle greater than 0, but less than 90 degrees). The oblique angle of deposition results in an increase in the anisotropy field.

In another embodiment, a storage device comprises: a chassis; a spindle motor coupled to the chassis; one or more magnetic disks coupled to the spindle motor; an actuator arm coupled to the chassis; and a magnetic read head coupled to the actuator arm. The magnetic read head comprises: a bottom shield having an end that forms a portion of a media facing surface (MFS); a top shield disposed over the bottom shield, wherein the top shield has an end that forms a portion of the MFS; one or more seed layers disposed over the bottom shield; an antiferromagnetic layer disposed over the one or more seed layers; a pinned magnetic layer disposed on the antiferromagnetic layer, wherein a first portion of the pinned magnetic layer is recessed from the MFS and wherein the pinned magnetic layer has been processed at an oblique angle; a coupling layer disposed over the pinned magnetic layer, wherein the coupling layer forms a portion of the MFS; a reference magnetic layer disposed over the coupling layer, wherein the reference magnetic layer forms a portion of the MFS; a spacer layer disposed over the reference magnetic layer, wherein the spacer layer forms a portion of the MFS; a free magnetic layer disposed over the insulating layer, wherein the free magnetic layer forms a portion of the MFS; and a capping layer disposed over the free magnetic layer, wherein the capping layer forms a portion of the MFS.

### BRIEF DESCRIPTION OF THE DRAWINGS

So that the manner in which the above recited features can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an exemplary magnetic disk drive, according to an embodiment of the invention.

FIG. 2 is a side view of a read/write head and magnetic disk of the disk drive of FIG. 1, according to one embodiment of the invention.

FIG. 3 is a schematic cross-sectional illustration of a magnetic read head sensor according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

The embodiments disclosed generally relate to a magnetic read head having a recessed antiferromagnetic layer and a recessed pinned magnetic layer. The recessed pinned magnetic layer is only partially recessed from the MFS, but the recess amount is the same amount as the antiferromagnetic layer. The recess is between about 50 nm and about 200 nm. The recess results in an increase in the anisotropy field. The recess is due to processing the pinned magnetic layer and the antiferromagnetic layer at an oblique angle.

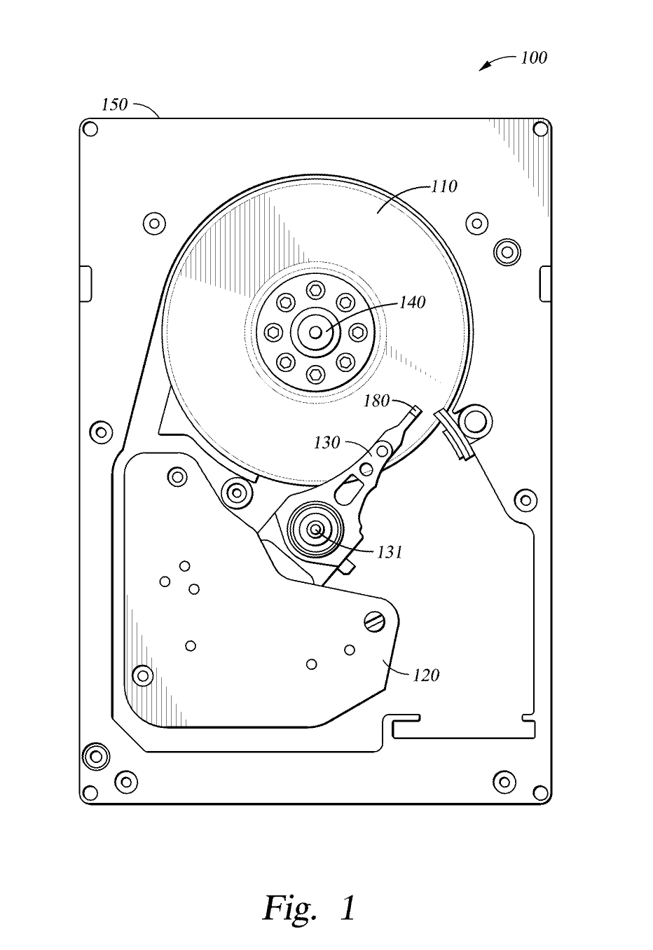

FIG. 1 illustrates a top view of an exemplary hard disk drive (HDD) 100, according to an embodiment of the invention. As illustrated, HDD 100 may include one or more magnetic disks 110, actuator 120, actuator arms 130 associated with each of the magnetic disks 110, and spindle motor 140 affixed in a chassis 150. The one or more magnetic disks 110 may be arranged vertically as illustrated in FIG. 1. Moreover, the one or more magnetic disks may be coupled with the spindle motor 140.

Magnetic disks 110 may include circular tracks of data on both the top and bottom surfaces of the disk. A magnetic head 180 mounted on a slider may be positioned on a track. As each disk spins, data may be written on and/or read from the data track. Magnetic head 180 may be coupled to an actuator arm 130 as illustrated in FIG. 1. Actuator arm 130 may be configured to swivel around actuator axis 131 to place magnetic head 180 on a particular data track.

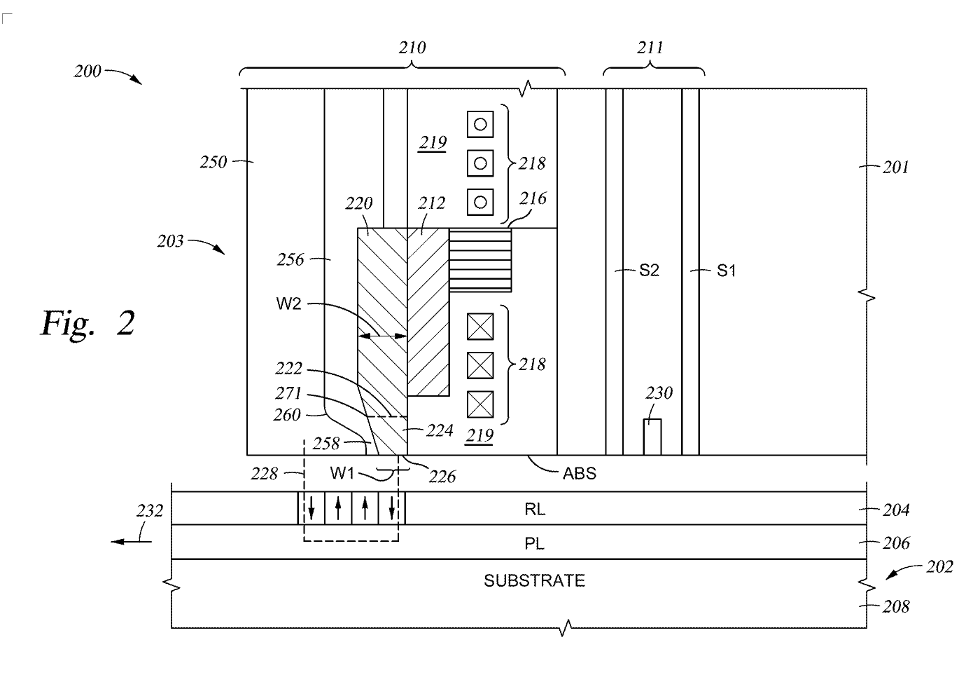

FIG. 2 is a fragmented, cross-sectional side view through the center of a read/write head 200 mounted on a slider 201 and facing magnetic disk 202. The read/write head 200 and magnetic disk 202 may correspond to the magnetic head 180 and magnetic disk 110, respectively in FIG. 1. In some embodiments, the magnetic disk 202 may be a “dual-layer” medium that includes a perpendicular magnetic data recording layer (RL) 204 on a “soft” or relatively low-coercivity magnetically permeable underlayer (PL) 206 formed on a disk substrate 208. The read/write head 200 includes an MFS, a magnetic write head 210 and a magnetic read head 211, and is mounted such that the MFS is facing the magnetic disk 202. In FIG. 2, the disk 202 moves past the write head 210 in the direction indicated by the arrow 232, so the portion of slider 201 that supports the read/write head 200 is often called the slider “trailing” end 203.

The magnetic read head 211 is a MR read head that includes a MR sensing element 230 located between MR shields S1 and S2, which are composed of a highly permeable and magnetically soft material such as permalloy. The distance between S1 and S2, which is the sensor thickness, defines the read gap of the read head. The RL 204 is illustrated with perpendicularly recorded or magnetized regions, with adjacent regions having magnetization directions, as represented by the arrows located in the RL 204. The magnetic fields of the adjacent magnetized regions are detectable by the MR sensing element 230 as the recorded bits.

The write head 210 includes a magnetic circuit made up of a main pole 212 and a yoke 216. The write head 210 also includes a thin film coil 218 shown in the section embedded in non-magnetic material 219 and wrapped around yoke 216. In an alternative embodiment, the yoke 216 may be omitted, and the coil 218 may wrap around the main pole 212. A write pole 220 is magnetically connected to the main pole 212 and has an end 226 that defines part of the MFS of the magnetic write head 210 facing the outer surface of disk 202.

Write pole 220 is a flared write pole and includes a flare point 222 and a pole tip 224 that includes an end 226 that defines part of the MFS. The flare may extend the entire height of write pole 220 (i.e., from the end 226 of the write pole 220 to the top of the write pole 220), or may only extend from the flare point 222, as shown in FIG. 2. In one embodiment the distance between the flare point 222 and the MFS is between about 30 nm and about 150 nm.

The write pole 220 includes a tapered surface 271 which increases a width of the write pole 220 from a first width W1 at the MFS to a second width W2 away from the MFS. In one embodiment, the width W1 may be between around 60 nm and 200 nm, and the width W2 may be between around 120 nm and 350 nm. While the tapered region 271 is shown with a single straight surface in FIG. 2, in alternative embodiment, the tapered region 271 may include a plurality of tapered surface with different taper angles with respect to the MFS.

The tapering improves magnetic performance. For example, reducing the width W1 at the MFS may concentrate a magnetic field generated by the write pole 220 over desirable portions of the magnetic disk 202. In other words, reducing the width W1 of the write pole 220 at the MFS reduces the probability that tracks adjacent to a desirable track are erroneously altered during writing operations.

While a small width of the write pole 220 is desired at the MFS, it may be desirable to have a greater width of the write pole 220 in areas away from the MFS. A larger width W2 of the write pole 220 away from the MFS may desirably increase the magnetic flux to the write pole 220, by providing a greater thickness of the write pole 220 in a direction generally parallel to the MFS. In operation, write current passes through coil 218 and induces a magnetic field (shown by dashed line 228) from the write pole 220 that passes through the RL 204 (to magnetize the region of the RL 204 beneath the write pole 220), through the flux return path provided by the PL 206, and back to an upper return pole 250. In one embodiment, the greater the magnetic flux of the write pole 220, the greater is the probability of accurately writing to desirable regions of the RL 204.

FIG. 2 further illustrates one embodiment of the upper return pole or magnetic shield 250 that is separated from write pole 220 by a nonmagnetic gap layer 256. In some embodiments, the magnetic shield 250 may be a trailing shield wherein substantially all of the shield material is on the trailing end 203. Alternatively, in some embodiments, the magnetic shield 250 may be a wrap-around shield wherein the shield covers the trailing end 203 and also wraps around the sides of the write pole 220. As FIG. 2 is a cross section through the center of the read/write head 200, it represents both trailing and wrap-around embodiments.

Near the MFS, the nonmagnetic gap layer 256 has a reduced thickness and forms a shield gap throat 258. The throat gap width is generally defined as the distance between the write pole 220 and the magnetic shield 250 at the MFS. The shield 250 is formed of magnetically permeable material (such as Ni, Co and Fe alloys) and gap layer 256 is formed of nonmagnetic material (such as Ta, TaO, Ru, Rh, NiCr, SiC or Al₂O₃). A taper 260 in the gap material provides a gradual transition from the throat gap width at the MFS to a maximum gap width above the taper 260. This gradual transition in width forms a tapered bump in the non-magnetic gap layer that allows for greater magnetic flux density from the write pole 220, while avoiding saturation of the shield 250.

It should be understood that the taper 260 may extend either more or less than is shown in FIG. 2. The taper may extend upwards to an end of shield 250 opposite the MFS (not shown), such that the maximum gap width is at the end of the shield opposite the MFS. The gap layer thickness increases from a first thickness (the throat gap width) at the MFS to greater thicknesses at a first distance from the MFS, to a final thickness at a second distance (greater than the first distance) from the MFS.

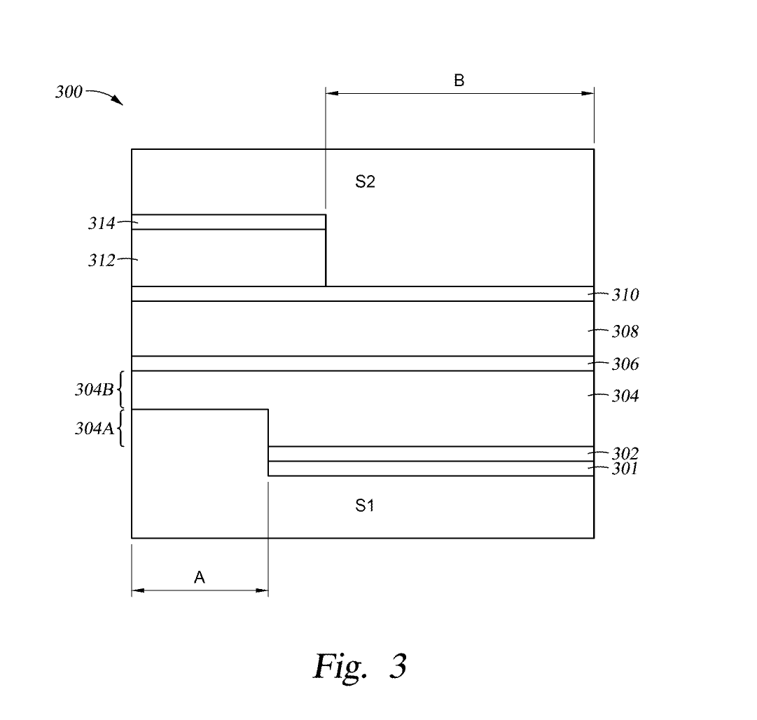

FIG. 3 is a schematic cross-sectional illustration of a magnetic read head sensor 300 according to one embodiment. The sensor 300 includes a bottom shield S1 and a top shield S2. The bottom and top shields S1, S2 may comprise a ferromagnetic material. Suitable ferromagnetic materials that may be utilized include Ni, Fe, Co, NiFe, NiFeCo, NiCo, CoFe and combinations thereof. Both the bottom and top shields S1, S2 extend to the MFS. Both the bottom and top shields S1, S2 extend from the MFS for a distance that is greater than the distance that the free magnetic layer 312 (to be discussed later) extends.

Over the bottom shield S1, one or more seed layers 301 are present to promote the optimal grain size and texture of an antiferromagnet. An antiferromagnetic layer 302 is deposited on the one or more seed layers 301. The one or more seed layers 301 may comprise Ta, Ru, NiFe, NiFeCr or combinations thereof and may be deposited at an angle that is oblique (i.e., the deposition angle is greater than 0 degrees and less than 90 degrees). The antiferromagnetic layer 302 may comprise Pt, Ir, Rh, Ni, Fe, Mn, or combinations thereof such as PtMn, PtPdMn, NiMn or IrMn. The antiferromagnetic layer 302 has a thickness of about 60 Angstroms. As shown in FIG. 3, the antiferromagnetic layer 302 is recessed from the MFS by a distance shown by arrows “A”. In one embodiment, the distance “A” is between about 50 nm and about 200 nm.

A pinned magnetic layer 304 is deposited on the antiferromagnetic layer 302. As shown in FIG. 3, the pinned magnetic layer 304 has a first portion 304A that is recessed from the MFS and a second portion 304B that has a surface at the MFS. The first portion 304A is recessed by a distance shown by arrows “A” and is thus, recessed the same distance from the MFS as the antiferromagnetic layer 302. The pinned magnetic layer 304 may comprise one or more magnetic materials such as, for example NiFe, CoFe, CoFeB, or diluted magnetic alloys. As will be discussed below, the pinned magnetic layer 304 extends from the MFS a greater distance than the free magnetic layer 312.

A nonmagnetic coupling layer 306 is deposited on the pinned magnetic layer 304. The coupling layer 308 may comprise Ru, Cr, Ir, Rh or combinations thereof. A reference magnetic layer 308 is deposited on the nonmagnetic coupling layer 306. The reference magnetic layer 308 may comprise one or more magnetic materials such as, for example NiFe, CoFe, CoFeB, or diluted magnetic alloys. Unlike the pinned magnetic layer 304, the reference magnetic layer 308 has a substantially uniform thickness throughout.

A spacer layer 310 is deposited on the reference magnetic layer 308. In the case of a TMR sensor, the spacer layer 310 comprises an insulating material such as MgO, TiO₂ or alumina. For a GMR sensor, the spacer layer 310 may comprise a conductive material such as Cu, Ag, or AgSn.

A free magnetic layer 312 is deposited on the spacer layer 310. The free magnetic layer 312 may comprise Co, Fe, B, Co, CoFe, CoFeB, NiFe, CoHf or combinations thereof. The free magnetic layer 312 may comprise a single layer of magnetic material or, in other embodiments multiple layers. The free magnetic layer layer 312 has a thickness of between about 15 Angstroms to about 75 Angstroms. The free magnetic layer 312 has an end at the MFS, but does not extend as far as the reference and pinned magnetic layer 304, 308. Rather, the reference and pinned magnetic layers 304, 308 extend for a distance shown by arrows “B” beyond the distance that the free magnetic layer 312 extends. Because the pinned magnetic layer 304 and the reference magnetic layer 308 extend from the MFS a greater distance than the free magnetic layer 312, the magnetization direction of the pinned and reference magnetic layers 304, 308 is fixed parallel to the length of the layers 304, 308.

A capping layer 314 is disposed on the free magnetic layer 312. The capping layer 312 extends for the same distance as the free magnetic layer 312 and comprises hafnium, ruthenium, tantalum or combinations thereof. The capping layer 314 has a thickness of between about 15 Angstroms and about 75 Angstroms. In some embodiments, the capping layer 314 may comprise multiple layers. The top shield S2 is disposed on the capping layer 314.

As shown in FIG. 3, the bottom shield S1 fills in the area of the recess between the MFS and the antiferromagnetic layer 302 and the first portion 304A of the pinned magnetic layer 304. It is to be understood that the material in the recess may be the bottom shield S1 as shown or may comprise separate, additional layers of magnetic material that are distinct from the bottom shield S1. Similarly, the top shield S2 fills in the area above the spacer layer 310 adjacent the free magnetic layer 312 and capping layer 314. It is to be understood that while the top shield S2 is shown as filling in the area adjacent the free magnetic layer 312 shown by arrows “B”, the area may comprise separate, additional layers of magnetic material that are distinct from the top shield S2, or insulating materials such as TaO.

In order to recess the antiferromagnetic layer 302 and the first portion 304A of the pinned magnetic layer 304 from the MFS, the antiferromagnetic layer 302 and the pinned magnetic layer 304 may be deposited and then milled back. Alternatively, the antiferromagnetic layer 302 and the pinned magnetic layer 304 may be selectively deposited so that the layers do not extend all the way to the MFS. In either process, the angle of the milling or the angle of the deposition affects the anisotropic magnetic field (i.e., Hk). If the milling angle or the deposition angle is greater than 0 degrees and less than 90 degrees (i.e., oblique), the anisotropic magnetic field increases. Specifically, the oblique processing of the pinned magnetic layer 304 and the antiferromagnetic layer 302 leads to a high perpendicular Hk in both the pinned magnetic layer 304 and the reference magnetic layer 308, which improves the reader pinning stability. The increase in the Hk is necessary due to the decrease in Hk that occurs with the recessed antiferromagnetic layer 302 as compared to an antiferromagnetic layer that extends to the MFS. When an antiferromagnetic layer is recessed from the MFS, the magnetization in the pinned magnetic layer and reference magnetic layer is reduced. By processing the first portion 304A of the pinned magnetic layer 304 and the antiferromagnetic layer 302 at an oblique angle, the pinning direction can be maintained due to the stronger Hk. In other words, the oblique treatment of the pinned magnetic layer 304 and the antiferromagnetic layer 302 leads to improved reader pinning stability. Additionally, the oblique treatment of the antiferromagnetic layer 302 and the pinned magnetic layer 304 induces a uniaxial strain in a direction along the length of the layers. The oblique treatment increases the magnetostriction coefficient for the pinned and reference magnetic layers 304, 308.

Having the antiferromagnetic layer 302 and the first portion 304A of the pinned magnetic layer 304 recessed from the MFS reduces the read gap, which increases the resolution of the read head sensor 300. By processing the pinned magnetic layer 304 and the antiferromagnetic layer 302 and its seed layers 301 at an oblique angle, Hk is increased and the pinning stability is increased.

While the foregoing is directed to exemplary embodiments, other and further embodiments of the invention may be devised without departing from the basic scope thereof, and the scope thereof is determined by the claims that follow.

What is claimed is:

1. A magnetic read head, comprising:
a bottom shield having an end that forms a portion of a media facing surface (MFS);
a top shield disposed over the bottom shield, wherein the top shield has an end that forms a portion of the MFS;
one or more seed layers disposed over the bottom shield;
an antiferromagnetic layer disposed over the one or more seed layers;
a pinned magnetic layer disposed on the antiferromagnetic layer, wherein a first portion of the pinned magnetic layer is recessed from the MFS and wherein the pinned magnetic layer has been processed at an oblique angle;
a coupling layer disposed over the pinned magnetic layer, wherein the coupling layer forms a portion of the MFS;
a reference magnetic layer disposed over the coupling layer, wherein the reference magnetic layer forms a portion of the MFS;
a spacer layer disposed over the reference magnetic layer, wherein the spacer layer forms a portion of the MFS;
a free magnetic layer disposed over the insulating layer, wherein the free magnetic layer forms a portion of the MFS; and
a capping layer disposed over the free magnetic layer, wherein the capping layer forms a portion of the MFS.

2. The magnetic read head of claim 1, wherein the first portion of the pinned magnetic layer is recessed from the MFS by a distance of between about 50 nm and about 200 nm.

3. The magnetic read head of claim 1, wherein the antiferromagnetic layer comprises Pt, Ir, Rh, Ni, Fe, Mn, PtMn, PtPdMn, NiMn, IrMn or combinations thereof.

4. The magnetic read head of claim 1, wherein a pinned magnetic layer additionally has a second portion extending to the MFS.

5. The magnetic read head of claim 1, wherein the pinned magnetic layer extends from the MFS a first distance that is greater than a second distance from the MFS which the free magnetic layer extends.

6. The magnetic read head of claim 1, wherein the bottom shield is disposed between the first portion of the pinned magnetic layer and the MFS.

7. The magnetic read head of claim 1, wherein the spacer layer comprises an insulating material.

8. The magnetic read head of claim 7, wherein the insulating material comprises MgO.

9. The magnetic read head of claim 1, wherein the spacer layer comprises an electrically conductive material.

10. The magnetic read head of claim 9, wherein the spacer layer comprises copper.

11. The magnetic read head of claim 1, wherein the one or more seed layers comprise tantalum, ruthenium, or combinations thereof and have been deposited at an oblique angle.

12. A magnetic read head, comprising:
a bottom shield having an end that forms a portion of a media facing surface (MFS);
a top shield disposed over the bottom shield, wherein the top shield has an end that forms a portion of the MFS;
one or more seed layers disposed on the bottom shield;
an antiferromagnetic layer disposed over the one or more seed layers, wherein the antiferromagnetic layer is recessed from the MFS and wherein the antiferromagnetic layer has been processed at an oblique angle;
a pinned magnetic layer disposed on the antiferromagnetic layer, wherein a portion of the pinned magnetic layer is recessed from the MFS and wherein the pinned magnetic layer has been processed at an oblique angle;
a coupling layer disposed over the pinned magnetic layer, wherein the coupling layer forms a portion of the MFS;
a reference magnetic layer disposed over the coupling layer, wherein the reference magnetic layer forms a portion of the MFS;
a spacer layer disposed over the reference magnetic layer, wherein the spacer layer forms a portion of the MFS;
a free magnetic layer disposed over the insulating layer, wherein the free magnetic layer forms a portion of the MFS; and
a capping layer disposed over the free magnetic layer, wherein the capping layer forms a portion of the MFS.

13. The magnetic read head of claim 12, wherein the first portion of the pinned magnetic layer is recessed from the MFS by a distance of between about 50 nm and about 200 nm.

14. The magnetic read head of claim 12, wherein the antiferromagnetic layer comprises Pt, Ir, Rh, Ni, Fe, Mn, PtMn, PtPdMn, NiMn, IrMn or combinations thereof.

15. The magnetic read head of claim 12, wherein a pinned magnetic layer additionally has a second portion extending to the MFS.

16. The magnetic read head of claim 12, wherein the pinned magnetic layer extends from the MFS a first distance that is greater than a second distance from the MFS which the free magnetic layer extends.

17. The magnetic read head of claim 12, wherein the bottom shield is disposed between the first portion of the pinned magnetic layer and the MFS.

18. The magnetic read head of claim 12, wherein the spacer layer comprises an insulating material.

19. The magnetic read head of claim 18, wherein the insulating material comprises MgO.

20. The magnetic read head of claim 12, wherein the antiferromagnetic layer is recessed from the MFS by a distance of between about 50 nm and about 200 nm.

21. The magnetic read head of claim 12, wherein the one or more seed layers comprise tantalum, ruthenium, or combinations thereof and have been deposited at an oblique angle.

22. The magnetic read head of claim 12, wherein the pinned magnetic layer has been processed at an oblique angle and wherein the first portion of the pinned magnetic layer is recessed from the MFS by a distance of between about 50 nm and about 200 nm, the magnetic read head further comprising:
a reference magnetic layer disposed over the spacer layer, wherein the reference magnetic layer forms a portion of the MFS; and
an insulating layer disposed over the reference magnetic layer, wherein the insulating layer forms a portion of the MFS.

23. The magnetic read head of claim 22, wherein the pinned magnetic layer extends from the MFS a first distance that is greater than a second distance from the MFS which the free magnetic layer extends.

24. The magnetic read head of claim 22, wherein the bottom shield is disposed between the first portion of the pinned magnetic layer and the MFS.

25. The magnetic read head of claim 22, wherein the one or more seed layers comprise tantalum, ruthenium, or combinations thereof and have been deposited at an oblique angle.

26. A storage device, comprising:
a chassis;
a spindle motor coupled to the chassis;
one or more magnetic disks coupled to the spindle motor;
an actuator arm coupled to the chassis; and
a magnetic read head coupled to the actuator arm, wherein the magnetic read head comprises:
a bottom shield having an end that forms a portion of a media facing surface (MFS);
a top shield disposed over the bottom shield, wherein the top shield has an end that forms a portion of the MFS;
one or more seed layers disposed over the bottom shield;
an antiferromagnetic layer disposed over the one or more seed layers;
a pinned magnetic layer disposed on the antiferromagnetic layer, wherein a first portion of the pinned magnetic layer is recessed from the MFS and wherein the pinned magnetic layer has been processed at an oblique angle;
a coupling layer disposed over the pinned magnetic layer, wherein the coupling layer forms a portion of the MFS;
a reference magnetic layer disposed over the coupling layer, wherein the reference magnetic layer forms a portion of the MFS;
a spacer layer disposed over the reference magnetic layer, wherein the spacer layer forms a portion of the MFS;
a free magnetic layer disposed over the insulating layer, wherein the free magnetic layer forms a portion of the MFS; and
a capping layer disposed over the free magnetic layer, wherein the capping layer forms a portion of the MFS.

27. The storage device of claim 26, wherein the first portion of the pinned magnetic layer is recessed from the MFS by a distance of between about 50 nm and about 200 nm.

28. The storage device of claim 26, wherein the antiferromagnetic layer comprises Pt, Ir, Rh, Ni, Fe, Mn, PtMn, PtPdMn, NiMn, IrMn or combinations thereof.

29. The storage device of claim 26, wherein a pinned magnetic layer additionally has a second portion extending to the MFS.

30. The storage device of claim 26, wherein the pinned magnetic layer extends from the MFS a first distance that is greater than a second distance from the MFS which the free magnetic layer extends.
